(19) United States
(12) Patent Application Publication
(10) Pub. No.: US 2022/0317961 A1
(43) Pub. Date: Oct. 6, 2022

(54) METHOD FOR OPERATING A DISPLAY DEVICE IN A VEHICLE

(71) Applicant: Robert Bosch GmbH, Stuttgart (DE)

(72) Inventor: Anja Kommer, Stuttgart (DE)

(21) Appl. No.: 17/596,039

(22) PCT Filed: May 22, 2020
(86) PCT No.: PCT/EP2020/064302

§ 371 Date: Dec. 2, 2021

(30) Foreign Application Priority Data
Jun. 17, 2019 (DE) 10 2019 208 763.9

(51) Int. Cl. G06F 3/14; G06T 11/40; G06T 11/20

(52) U.S. Cl. CPC G06F 3/14; G06T 11/40; G06T 11/203; B60K 35/00

(57) ABSTRACT

A method for operating a display device in a vehicle for displaying a symbol and/or a character of a vehicle-relevant value on the display device. A frame is represented around the symbol and/or the character as a function of a priority of the vehicle-relevant value. The frame is represented in the same color as the symbol and/or the character.

### FIELD

The present invention relates to a method for operating a display device in a vehicle. The display device is also an object of the present invention.

### BACKGROUND INFORMATION

A method for displaying multiple pieces of information is described in German Patent No. DE 195 07 997 B4.

### SUMMARY

In accordance with an example embodiment of the present invention, a method is provided for operating a display device in a vehicle for displaying a symbol and/or a character of a vehicle-relevant value on the display device, a frame being represented around the symbol and/or the character as a function of a priority of the vehicle-relevant value, and the frame being represented in the same color as the symbol and/or the character.

A display device may, for example, be situated in an instrument cluster and/or in a dashboard, in particular, of a vehicle. Information may be displayed to a driver and/or a passenger with the aid of a display device. For example, information about the vehicle condition may be displayed. For example, a vehicle mode may be displayed with the aid of a display device. The output information may, for example, be information about the vehicle condition, such as the speed, the rotational speed indicator, the tank fill level and/or information about a vehicle navigation and/or information of an entertainment system. A display device may also be referred to as a display unit.

The priority of the vehicle-relevant value is defined, for example, based on a condition of the vehicle-relevant value, and thus based on a condition of the vehicle. A vehicle-relevant value should be perceived with a higher priority by a driver when, for example, a critical condition of the specific value, and thus a critical value, has been reached. The reaching of a critical condition or of a critical, vehicle-relevant value may, for example, be defined with the aid of the reaching of a defined threshold value. Preferably, a frame may be represented around the symbol and/or the character as a function of an established threshold value of the vehicle-relevant value being reached. In this way, in particular, a priority of the vehicle-relevant value may be established or defined.

An advantage of the present invention is that a driver of a vehicle, in particular, receives enhanced visual feedback about the condition of the vehicle. As a result of the appropriate representation, it is preferably possible to reduce or prevent the possible overlooking of the symbol and/or the character. Furthermore, a distraction of the driver by the representation may be avoided, or at least be reduced, so that, in particular, the driving safety is not or is hardly jeopardized. In other words, a priority of a vehicle-relevant value, in particular, the critical condition of a vehicle-relevant value, is pointed out to the driver with the aid of the representation of a frame, the likelihood of this being possibly overlooked being decreased. However, the driver is not unnecessarily distracted from the driving process or the events outside the vehicle, and thus the surroundings of the vehicle. A driver may thus continue to concentrate on driving the vehicle, by which the safety in road traffic or, for example, on a race track may be ensured or increased. Preferably, the attention of the driver may be attracted with the aid of the representation according to the present invention, without resulting in increased distraction. In particular, the legibility of the vehicle-relevant value, which, for example, represents a warning, is improved, and the symbol and/or the numerical value and/or the character is/are preferably not impaired. As a result of the appropriate representation, a driver in a vehicle is not unnecessarily distracted, by which a driver may, in particular, operate a vehicle more safely and/or more reliably. In other words, the display device should provide an easily legible overview of the conditions of the vehicle-relevant values so that the driver may act accordingly at an early stage. In particular, it is thus possible to prevent the warning notice from possibly being overlooked, the driver not being or hardly being distracted.

In one advantageous embodiment of the present invention, the frame may be represented in a flashing manner when a threshold value of the vehicle-relevant value has been reached. In this way, a driver may, in particular, receive a two-stage visual feedback, by which he or she is better able to assess how high the priority of the vehicle-relevant value is for the condition of the vehicle. In this way, a driver may, in particular, assess how critical the condition of a vehicle-relevant value has already become. In other words, a driver may, in particular, be given a feedback about a priority of a vehicle-relevant value, and thus about a critical level of a vehicle-relevant value for a vehicle. A flashing frame for a vehicle thus means that a critical level with respect to the vehicle-relevant value has been reached. A driver is preferably not unnecessarily distracted from the driving process on the road and/or on the race track by the representation according to the present invention. Furthermore, a driver is, in particular, not distracted for a long time from the driving process, it being possible, in particular, that a distraction of a driver over a long time may result in a hazardous situation during an operation of a vehicle, for example in an accident. In this way, the safety in road traffic and/or on the race track is enhanced by the representation according to the present invention. Furthermore, a driver may draw conclusions as to how long the warning has been displayed and how quickly an action on his or her part is necessary. As a result of, in particular, only the frame being defined as a flashing element, the legibility of the actual information, preferably the numerical value and/or the symbol and/or the character, is not impaired.

In one refinement of the present invention, the frame may be represented only around the symbol and/or the character. In this way, the variable to be considered or the vehicle-relevant value to be considered is pointed out directly to a driver. A driver is thus not distracted from a driving process for an unnecessarily long time, the critical value or an increased priority of a vehicle-relevant value being pointed out to him or her directly. In other words, a vehicle-relevant value to be prioritized is thus pointed out directly to a driver, or the driver's attention is directly drawn thereto, with the aid of the frame. In this way, in particular, the safety on the road and/or on a race track may be enhanced.

In one advantageous embodiment of the present invention, the vehicle-relevant value may be a tire pressure, a tire temperature, an oil temperature, an oil pressure, a transmission oil temperature, a cooling fluid or a brake temperature of the vehicle. In this way, in particular, a defined vehicle-relevant value may be displayed to a driver on the display device, especially a critical level, and thus a high priority of the vehicle-relevant value, being pointed out.

Furthermore, a priority of the vehicle-relevant value may be identified with the aid of a control unit of the display device. In this way, a secure and/or reliable assessment of the vehicle-relevant value may be made possible.

Furthermore, in accordance with an example embodiment of the present invention, a display device for a vehicle for displaying a symbol and/or a character of a vehicle-relevant value is provided, a frame being representable around the symbol and/or the character as a function of a priority of the vehicle-relevant value, and the frame being representable in the same color as the symbol and/or the character.

An advantage of the present invention is that a driver of a vehicle, in particular, receives enhanced visual feedback about the condition of the vehicle. The representation according to the present invention ensures that the likelihood of the symbol and/or of the character being possibly overlooked is reduced or prevented. Furthermore, a distraction of the driver by the representation may be avoided, or at least be reduced, so that, in particular, the driving safety is not or is hardly jeopardized. In other words, a priority of a vehicle-relevant value, in particular, the critical condition of a vehicle-relevant value, is pointed out to the driver with the aid of the representation of a frame. In this way, a driver may operate a vehicle, in particular, more safely and/or reliably.

In one refinement, the frame is representable in a flashing manner when a threshold value of the vehicle-relevant value has been reached. With the aid of this two-stage visual feedback, a driver may, in particular, better assess how high a priority of the vehicle-relevant value is to be rated for the condition of the vehicle. A driver may thus, in particular, infer a likelihood of a possible malfunction of a vehicle. In this way, a driver, in particular, receives feedback about a priority of a vehicle-relevant value, however without being unnecessarily distracted from the driving process on the road and/or on a race track. A flashing frame may, in particular, indicate that a critical level of the vehicle-relevant value has been reached. A driver is not unnecessarily distracted from the driving process on the road and/or on the race track with the aid of the representation according to the present invention. In this way, the safety in road traffic and/or on the race track is enhanced by the representation according to the present invention. Furthermore, a driver may draw conclusions as to how long the warning has been displayed and how quickly an action on his or her part is necessary.

In one exemplary embodiment of the present invention, the frame is representable only around the symbol and/or the character. The variable to be considered or the vehicle-relevant value to be considered, and thus the priority of the vehicle-relevant value, may thus be pointed out directly or specifically to a driver. A distraction of the driver from a driving process may thus be reduced and/or prevented, by which a driver may operate the vehicle, in particular, safely and/or reliably. In this way, in particular, the safety in road traffic and/or on a race track may be enhanced.

The vehicle-relevant information may preferably be a tire pressure, a tire temperature, an oil temperature, an oil pressure, a transmission oil temperature, a cooling fluid or a brake temperature of the vehicle. In this way, in particular, a defined vehicle-relevant value may be represented to a driver on the display device, in particular a critical level, and thus a high priority of the vehicle-relevant value, being pointed out.

In one advantageous embodiment of the present invention, the display device may be a freely programmable combination instrument. In this way, the representation on the display device may, in particular, be individually adapted to the driving process.

In one refinement of the present invention, the display device includes a control unit for identifying a priority of the vehicle-relevant value. The control unit may preferably be configured to receive and to process sensor data from vehicle sensors for identifying a priority of the vehicle-relevant value. In this way, a secure and/or reliable assessment of the vehicle-relevant value may be made possible.

Furthermore, a vehicle including a display device for a vehicle for displaying a symbol and/or a character of a vehicle-relevant value is described.

### BRIEF DESCRIPTION OF THE DRAWINGS

Exemplary embodiments of the present invention are shown in the figures and are described in greater detail below. Identical reference numerals are used for similarly acting elements shown in the different figures, and a repeated description of the elements is dispensed with.

FIG. 1 shows a schematic representation of a top view of a vehicle according to one exemplary embodiment of the present invention.

FIG. 2 shows a schematic representation of a section of a vehicle according to one exemplary embodiment of the present invention.

FIG. 3 shows a schematic representation of a display device according to one exemplary embodiment of the present invention.

FIG. 4 shows a schematic representation of a display device according to one exemplary embodiment of the present invention.

FIG. 5 shows a schematic representation of a display device according to one exemplary embodiment of the present invention.

FIG. 6 shows a schematic representation of a method for operating a display device according to one exemplary embodiment of the present invention.

### DETAILED DESCRIPTION OF EXAMPLE EMBODIMENTS

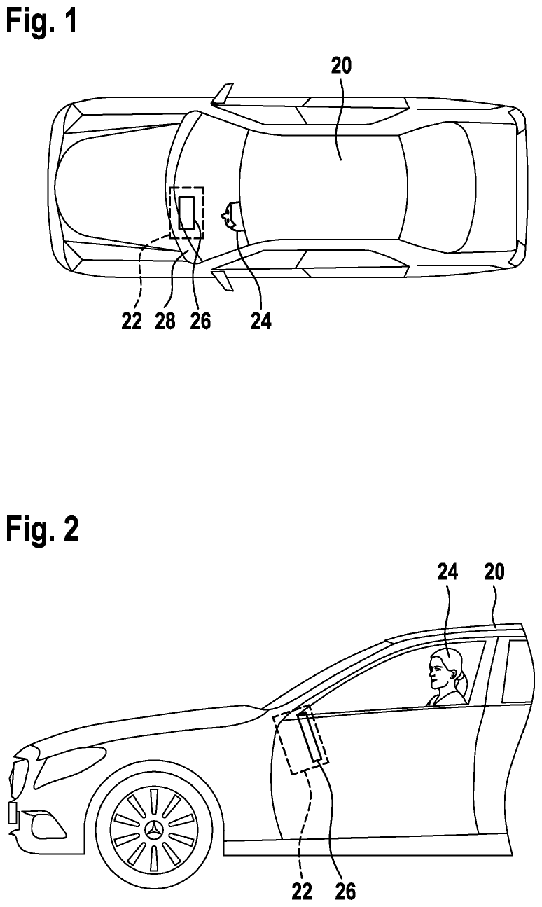

FIG. 1 shows a schematic representation of a top view of a vehicle 20, for example a motor vehicle, for example a car, including a display device 22. In one refinement, however, vehicle 20 may also be a race car, a motorcycle or a commercial vehicle. Display device 22 is designed to display at least one image representation for an observer 24 of display device 22. Display device 22 preferably includes a display surface 26 and may, for example, be situated in an instrument panel 28 or a dashboard 28 of vehicle 20. With the aid of display device 22, in particular display surface 26, information with respect to vehicle 20, for example vehicle condition information or information about a vehicle mode, such as for example a speed and/or a rotational speed and/or a temperature and/or a tank fill level and/or navigation instructions and/or information of a vehicle entertainment system and/or further information which may be used for the operation of a vehicle 20, may be displayed.

Display device 22 is situated in vehicle 20 in such a way that observer 24 is able to view the information represented with the aid of display device 22. An observer 24 may, in particular, be a vehicle occupant, for example a driver and/or a passenger of vehicle 20. As an alternative or in addition, display device 22 may be situated in another location in the dashboard of vehicle 20.

FIG. 2 shows a schematic representation of a section of a vehicle 20 from a side, including a display device 22. Display device 22 according to FIG. 2 may, in particular, be implemented in accordance with display device 22 according to FIG. 1.

Furthermore, display device 22 according to FIG. 2 may, in particular, be situated in the vehicle in accordance with display device 22 according to FIG. 1.

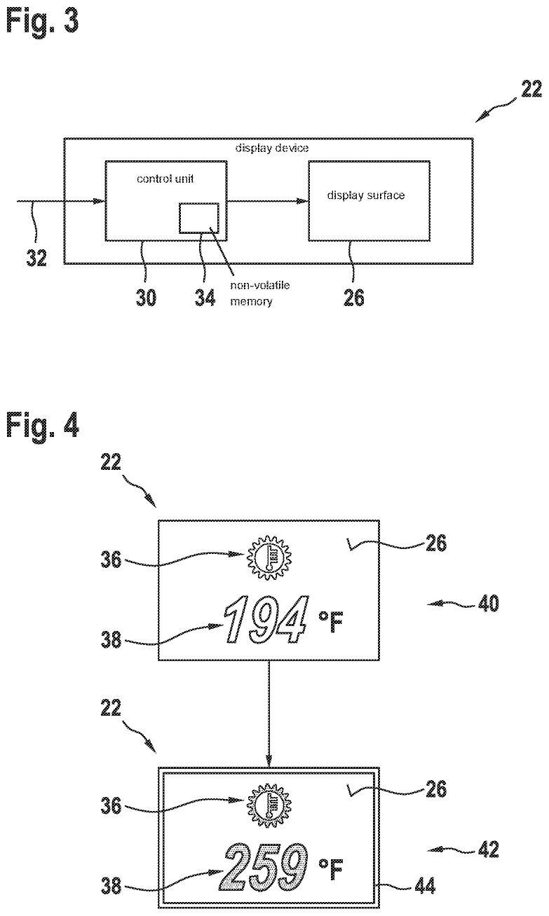

FIG. 3 shows a schematic representation of a display device 22 according to one exemplary embodiment of the present invention. Display device 22 according to FIG. 3 may, in particular, be implemented in accordance with display device 22 according to FIG. 1 and/or FIG. 2. Furthermore, display device 22 according to FIG. 3 may, in particular, be situated in a vehicle in accordance with display device 22 according to FIG. 1 and/or FIG. 2.

Display device 22 may, in particular, be a freely programmable, in particular, digital, combination instrument. This allows warning symbols or warning signs and/or corresponding characters to be represented, in particular at an edge of a display surface 26. In one refinement, warnings including additional information may, in particular, be represented in specific areas within the display surface 26. For enhancement, critical, vehicle-relevant values may, for example, be highlighted or represented with a warning color, for example yellow or red. In the process, either the warning sign itself may be represented in this color or the direct background may be highlighted in color.

Display device 22 includes a display surface 26 and a control unit 30. Control unit 30 may also be situated outside display device 22 in the vehicle. Display device 22, in particular display surface 26, is configured to display a symbol and/or a character of a vehicle-relevant value. The vehicle-relevant information may, in particular, be a tire pressure, a tire temperature, an oil temperature, an oil pressure, a transmission oil temperature, a cooling fluid or a brake temperature of the vehicle. These vehicle-relevant values may, for example, be recorded or measured with the aid of sensors in the vehicle.

Control unit 30 obtains or receives signals or data with respect to the vehicle-relevant values in accordance with or along arrow 32. The values picked up with the aid of the sensors may, in particular, be forwarded to control unit 30. Control unit 30 is configured to control display surface 26 of display device 22. In particular, control unit 30 controls a background lighting of display device 22 and/or display surface 26, which, for example, may be designed as a display, for example as an LCD display. As a function of a priority of the vehicle-relevant value, a frame may be represented around the symbol and/or the character, the frame being represented in the same color as the symbol and/or the character.

The priority of the vehicle-relevant value is defined, for example, based on a condition of the vehicle-relevant value, and thus based on a condition of the vehicle. When the vehicle-relevant value reaches, in particular, a critical condition or a critical level, it has to be perceived or be perceivable by the driver with higher priority. A critical level, and thus a higher priority, may, in particular, be defined as a certain threshold value of the vehicle-relevant value having been or being reached. In other words, a threshold value is defined, and when the vehicle-relevant value exceeds or falls below this threshold value, a critical level is identified or an increased priority of the vehicle-relevant value is identified. A driver of the vehicle thus has to be able to perceive the vehicle-relevant value with higher priority. For example, a certain temperature of the engine may be established as the threshold value, an increased priority being established when the certain temperature, as the threshold value, is exceeded.

For this purpose, control unit 30 may compare the received sensor data to stored threshold values. The threshold values may, for example, be stored on an internal, non-volatile memory 34 of control unit 30. In other words, control unit 30 compares measured vehicle-relevant values to stored threshold values to, in particular, infer a priority of the vehicle-relevant value, by which, in particular, a critical level of the vehicle-relevant value may be established. Corresponding to the priority, display surface 26 may be activated with the aid of control units 30.

FIG. 4 shows a schematic representation of a display device 22 according to one exemplary embodiment of the present invention. Display device 22 according to FIG. 4 may, in particular, be implemented in accordance with display device 22 according to FIG. 1 and/or FIG. 2 and/or FIG. 3. Furthermore, display device 22 according to FIG. 4 may, in particular, be situated in a vehicle in accordance with display device 22 according to FIG. 1 and/or FIG. 2.

Display device 22, in particular display surface 26, is configured to display a symbol 36 and/or a character 38 of a vehicle-relevant value. In this advantageous embodiment, in particular, a temperature is represented as character 38 in Fahrenheit and a corresponding symbol 36. The temperature may be a temperature of the oil and/or of the engine, for example.

In a first condition 40, symbol 36 and character 38 of the vehicle-relevant value, here the temperature, is represented in a first color, for example white. In first condition 40, the threshold value of the vehicle-relevant value is not yet exceeded, which was identified with the aid of a control unit, by which the vehicle-relevant value, in particular, does not have a high priority, and thus no critical value. In one further embodiment, symbol 36 and character 38 of the vehicle-relevant value cannot even be represented on the display surface in first condition 40.

When a control unit identifies that the vehicle-relevant value exceeds a first threshold value, a second condition 42 is defined for displaying symbol 36 and/or character 38. In second condition 42, the vehicle-relevant value thus exceeds a first threshold value, by which a prioritized consideration of the vehicle-relevant value is necessary, and thus a first critical level and an increased priority of the vehicle-relevant value are identified. As a function of the identified priority of the vehicle-relevant value, a frame 44 is representable around symbol 36 and/or character 38. In second condition 42, frame 44 is thus represented around symbol 36 and character 38 on display surface 26, at least on a portion of display surface 26. In other words, frame 44 surrounds symbol 36 and character 38. In one exemplary embodiment, the frame is only represented around the symbol and/or the character. Furthermore, in the second condition, symbol 36 and character 38 are represented in a second color, here orange, for example, the second color being different from the first color in first condition 40. The second color is likewise to indicate the priority of the vehicle-relevant value or draw attention thereto. Frame 44 is advantageously represented in the same color as symbol 36 and character 38.

Frame 44 may be designed to be solid or dotted. Furthermore, frame 44 may only represent a border. In one further embodiment, frame 44 may be filled or filled-in, in particular with a color. In this advantageous refinement, frame 44 has a rectangular design. In an alternative embodiment, frame 44 may also be designed to be round or oval, or be accordingly adapted to symbol 36 and/or to character 38.

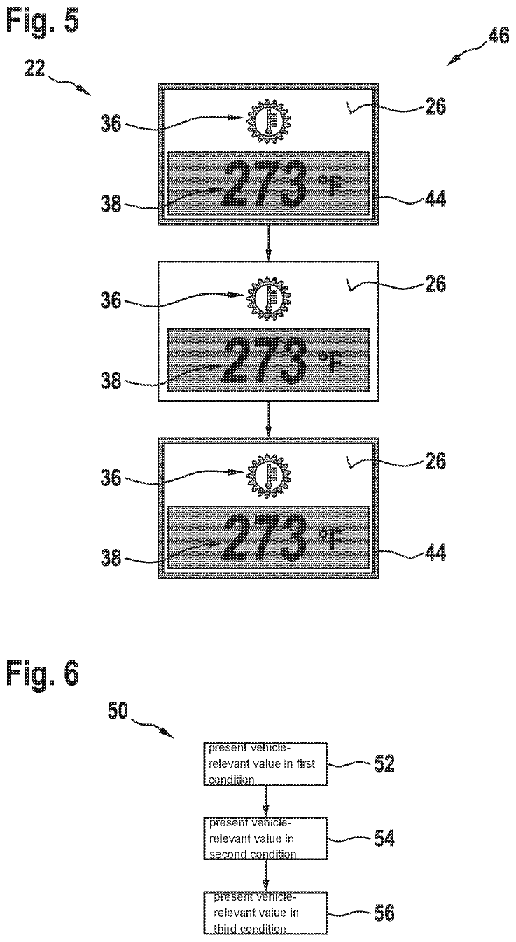

FIG. 5 shows a schematic representation of a display device 22 according to one exemplary embodiment of the present invention. Display device 22 according to FIG. 4 may, in particular, be implemented in accordance with display device 22 according to FIG. 1 and/or FIG. 2 and/or FIG. 3 and/or FIG. 4. Furthermore, display device 22 according to FIG. 5 may, in particular, be situated in a vehicle in accordance with display device 22 according to FIG. 1 and/or FIG. 2.

In this advantageous embodiment according to FIG. 5, display device 22 is represented in a third condition 46, frame 44 being representable in a flashing manner when a defined second threshold value of the vehicle-relevant value is reached. In other words, a second threshold value is defined, the second threshold value, in particular, being a more critical threshold value in relation to the first threshold value. When the second threshold value is reached, the vehicle-relevant value and, in particular, the critical condition of the vehicle-relevant value are thus pointed out to the driver with even greater intensity. The design of display device 22 according to FIG. 5 is to represent the flashing, third condition 46, a flashing meaning that the frame is alternately displayed and not displayed. For the flashing effect of flashing, frame 44 may be incrementally reduced in its brightness to obtain a flashing effect.

In other words, when a control unit identifies that the vehicle-relevant value exceeds the second threshold value, third condition 46 is defined for displaying symbol 36 and/or character 38. In third condition 46, the vehicle-relevant value thus exceeds the second threshold value, by which an increased, prioritized consideration of the vehicle-relevant value is necessary, and thus a second, critical level and an increased priority of the vehicle-relevant value are identified. Frame 44 is representable in a flashing manner as a function of the identified priority of the vehicle-relevant value. The design of frame 44 according to FIG. 5 may correspond to that of frame 44 according to FIG. 4, however, it being possible for the color to vary and frame 44 being represented accordingly in a flashing manner.

Furthermore, symbol 36, character 38, and frame 44 are, in particular, represented in a further third color, in this advantageous embodiment, in particular, in red. In one refinement, character 38 is highlighted, in particular, with the aid of a colored bar for a further illustration of the critical condition. In this embodiment, the colored bar, in particular, has the same color as symbol 36 and frame 44, character 38 then, in particular, being represented in the background color of display surface 26, and thus in black.

FIG. 6 shows a schematic representation of a method 50 for operating a display device in a vehicle for displaying a symbol and/or a character of a vehicle-relevant value on the display device according to one exemplary embodiment of the present invention. Display device 22 may be designed corresponding to the display device according to FIG. 1, FIG. 2, FIG. 3, FIG. 4 and/or FIG. 5.

In a first step 52 of method 50, the vehicle-relevant value is represented in a first condition. The first condition may be designed corresponding to the first condition according to FIG. 4 and may thus, in particular, corresponding to the first condition according to FIG. 3, be recognized based on a defined threshold value. In the first condition, the symbol and the character of the vehicle-relevant value are represented in a first color, for example white. In this way, it is signaled that the vehicle-relevant value is not in a critical condition and thus does not have to be considered with increased priority. The vehicle-relevant value may, for example, be a tire pressure, a tire temperature, an oil temperature, an oil pressure, a transmission oil temperature, a cooling fluid or a brake temperature of the vehicle.

In a second step 54 of method 50, a frame is represented around the symbol and/or the character when a priority of the vehicle-relevant value is recognized. In second step 54, the vehicle-relevant value is, in particular, represented corresponding to the second condition according to FIG. 4. Furthermore, the increased priority and thus the critical condition of the vehicle-relevant value corresponding to FIG. 3 are recognized or identified. The frame is represented in the same color as the symbol and/or the character, in particular in a second color. Furthermore, the frame may only be represented around the symbol and/or the character.

In a third step 56 of method 50, upon recognition of an increased priority of the vehicle-relevant value, the frame is represented in a flashing manner when a second threshold value of the vehicle-relevant value is reached. In third step 56, the vehicle-relevant value is, in particular, represented corresponding to the third condition according to FIG. 5. Furthermore, the increased priority and thus the critical, third condition or the even more critical, third condition in relation to the critical, second condition according to FIG. 3 and/or FIG. 5 are recognized or identified.

1-13. (canceled)

14. A method for operating a display device in a vehicle for displaying a symbol and/or a character of a vehicle-relevant value on the display device, the method comprising:
representing a frame around the symbol and/or the character as a function of a priority of the vehicle-relevant value;
wherein the frame is represented in the same color as the symbol and/or the character.

15. The method as recited in claim 14, wherein the frame is represented in a flashing manner when a threshold value of the vehicle-relevant value has been reached.

16. The method as recited in claim 14, wherein the frame is represented only around the symbol and/or the character.

17. The method as recited in claim 14, wherein the vehicle-relevant value is a tire pressure, or a tire temperature, or an oil temperature, or an oil pressure, or a transmission oil temperature, or a cooling fluid value, or a brake temperature, of the vehicle.

18. The method as recited in claim 14, wherein the priority of the vehicle-relevant value is identified using a control unit of the display device.

19. A display device for a vehicle configured to display a symbol and/or a character of a vehicle-relevant value, the display device being configured to represent a frame around the symbol and/or the character as a function of a priority of the vehicle-relevant value, and being configured to represent the frame in the same color as the symbol and/or the character.

20. The display device as recited in claim 19, wherein display device is configured to represent the frame in a flashing manner when a threshold value of the vehicle-relevant value has been reached.

21. The display device as recited in claim 19, wherein the display device is configured to represent the frame only around the symbol and/or the character.

22. The display device as recited in claim 19, wherein the vehicle-relevant value is a tire pressure, or a tire temperature, or an oil temperature, or an oil pressure, or a transmission oil temperature, or a cooling fluid value, or a brake temperature, of the vehicle.

23. The display device as recited in claim 19, wherein the display device is a freely programmable combination instrument.

24. The display device as recited in claim 19, wherein the display device includes a control unit configured to identify the priority of the vehicle-relevant value.

25. The display device as recited in claim 24, wherein the control unit is configured to receive and to process sensor data from vehicle sensors for identifying the priority of the vehicle-relevant value.

26. A vehicle including a display device configured to display a symbol and/or a character of a vehicle-relevant value, the display device being configured to represent a frame around the symbol and/or the character as a function of a priority of the vehicle-relevant value, and being configured to represent the frame in the same color as the symbol and/or the character.
